(19) United States
(12) Patent Application Publication
(10) Pub. No.: US 2022/0389260 A1
(43) Pub. Date: Dec. 8, 2022

(54) VISCOUS PYROGRAPHY COMPOSITION

(71) Applicant: Ann Pieta Lanfair, Oxford, NY (US)

(72) Inventor: Ann Pieta Lanfair, Oxford, NY (US)

(21) Appl. No.: 17/656,937

(22) Filed: Mar. 29, 2022

Related U.S. Application Data
(60) Provisional application No. 63/202,252, filed on Jun. 3, 2021.

(51) Int. Cl. C09D 15/00; C09D 7/61; C09D 7/43; C09D 7/65; C09D 5/02

(52) U.S. Cl. CPC C09D 15/00; C09D 7/61; C09D 7/43; C09D 7/65; C09D 5/02

(57) ABSTRACT

A pyrography composition includes ammonium chloride in an amount of about 2% to about 15% by weight; a thickener in an amount of about 10% to about 40% by weight; and water in an amount of about 50% to about 75% by weight of the total composition. The composition is a gel paste which, due to its high viscosity, remains stationary throughout the application process, maintaining edge retention for highly detailed design.

### CROSS-REFERENCE TO RELATED APPLICATION

This application claims the benefit of priority of U.S. provisional application No. 63/202,252, filed Jun. 3, 2021, the contents of which are herein incorporated by reference.

### BACKGROUND OF THE INVENTION

The present invention relates to compositions for treatment and decoration of wood and other compatible surfaces and, more particularly, to a viscous (i.e., paste or gel) pyrography composition.

Current pyrographic products and systems provide inferior transfer of designs onto wood products and other compatible surfaces. Existing devices and systems are unable to provide precise application of design(s) using stencils, transfers, or the like. Existing compositions tend to run, spoiling the design. Moreover, they do not provide the ability to easily complete large-scale projects.

As can be seen, there is a need for a means of applying pyrographic designs onto wood, wood products and other compatible surfaces, maximizing precision of the designs and minimizing leaks on the wood and other surfaces.

### SUMMARY OF THE INVENTION

In one aspect of the present invention, a pyrography composition is provided comprising: ammonium chloride in an amount of about 2% to about 15% of a total composition; a thickener in an amount of about 10% to about 40% of the total composition; and water in an amount of about 50% to about 75% of the total composition.

In another aspect of the present invention, a method of manufacturing a pyrography composition is provided, comprising: providing ammonium chloride in an amount of about 2% to about 15% by weight of the total composition; a thickener in an amount of about 10% to about 40% by weight of the total composition; and water in an amount of about 50% to about 75% by weight of the total composition; and mixing the ammonium chloride, the thickener, and the water to form a non-Newtonian fluid.

These and other features, aspects and advantages of the present invention will become better understood with reference to the following drawings, description, and claims.

### BRIEF DESCRIPTION OF THE DRAWINGS

FIG. 1 is a schematic view of a jar containing a composition according to an embodiment of the present invention;

FIG. 2 is a flow chart of a method of pyrography according to an embodiment of the present invention using the composition of FIG. 1;

FIG. 3 is a schematic view illustrating a step of the method of FIG. 2; and

FIG. 4 is schematic view illustrating a product produced thereby.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, one embodiment of the present invention is a paste or gel composition for pyrographic treatment and decoration of wood and other compatible surfaces. The composition may include ammonium chloride, a thickener, and water. The paste or gel state of the compositions minimizes leaking and runs.

Unless noted otherwise, all ratios and percentages disclosed herein are by weight.

The present invention provides a gel paste composition which, due to its high viscosity, remains stationary throughout the application process, maintaining edge retention for highly detailed design. The viscosity of the gel paste prevents compositions of the present invention from becoming fluid and following wood grain. The compositions of the present invention permit application of highly detailed designs in freehand, with a stencil, and with transfers. Any suitable viscosity may be used provided that the composition is at least a non-Newtonian fluid or has a solids content greater than that which forms a non-Newtonian fluid. For example, the apparent viscosity may be about 10 mPa·s or more.

Ammonium chloride breaks down to ammonia gas and hydrochloric acid when heated over 340° C., burning the surface on which it has been applied. Ammonium chloride may be present in amounts ranging from about 2% to about 15% by, such as about 8.47% to 11.63%.

Any suitable thickener may be used. Nonlimiting examples may include cornstarch and Maltodextrin. In one embodiment, the thickener may be THICK-IT® food thickener. The thickener may be selected from the group consisting of cornstarch, maltodextrin, THICK-IT® thickener and combinations thereof. The thickener, when gelled, maintains structure of the composition after application to the surface on which it has been placed. The thickener may be present in amounts ranging from about 10% to about 40%, such as about 13.95% to 37.29%.

Water, to dissolve and mix ingredients, may be present in amounts ranging from about 50% to about 75%, about 50%-70%, or about 54.24% to 74.42%.

In some embodiments, the composition may include a colorant or dye in an amount ranging from about 0.5% to about 10%.

In some embodiments, the composition may include a preservative such as a mold inhibitor or shelf stabilizer in an amount ranging from about 0.5% to about 10%, such as about 0.5% to about 5%. The mold inhibitor or shelf stabilizer may include any suitable preservative such as, but not limited to, potassium sorbate and vinegar.

A ratio of thickener to ammonium chloride may be about 1:1 to about 5:1.

A ratio of water to ammonium chloride may be about 6:1 to about 7:1.

A ratio of water to thickener may be about 1:1 to about 6:1.

In some embodiments, the inventive composition may be used in conjunction with a stamp pad or like container for use with branding irons, rubber stamps, hand stamps, mechanical stamps, decorative stamps/stamping to facilitate application of designs onto wood, wood products and other compatible surfaces to produce pyrographic designs.

In the following examples, a Torch Paste composition is prepared by providing Ammonium Chloride, THICK-IT® thickener, water, coloring dye, and mold inhibitor such that the total amount is 100%. The components are combined in a bowl or container and mixed thoroughly.

| Examples (wt.) | 1 | 2 | 3 | 4 | 5 |
|---|---|---|---|---|---|
| NH₄Cl, % | 2-15 | 8.47 | 2-15 | 2-15 | 11.63 |
| Thickener, % | 10-40 | 37.29 | 10-40 | 10-40 | 13.95 |
| Water, % | 50-75 | 54.24 | 50-75 | 50-75 | 74.42 |
| Colorant, % | 0 | 0 | 0.5-10 | 0.5-10 | 0 |
| Mold Inhibitor, % | 0 | 0 | 0.5-10 | 0.5-10 | 0 |

The present invention may be used by application to a substrate or other compatible surface as described herein. When the composition ingredients are combined in specific ratios, they produce a paste/gel that serves two functions. The paste/gel retains its structure for transfer of detailed designs onto wood and other compatible surfaces minimizing leakage. The composition also has good edge retention, maintaining clean precise lines while the burning process to take place.

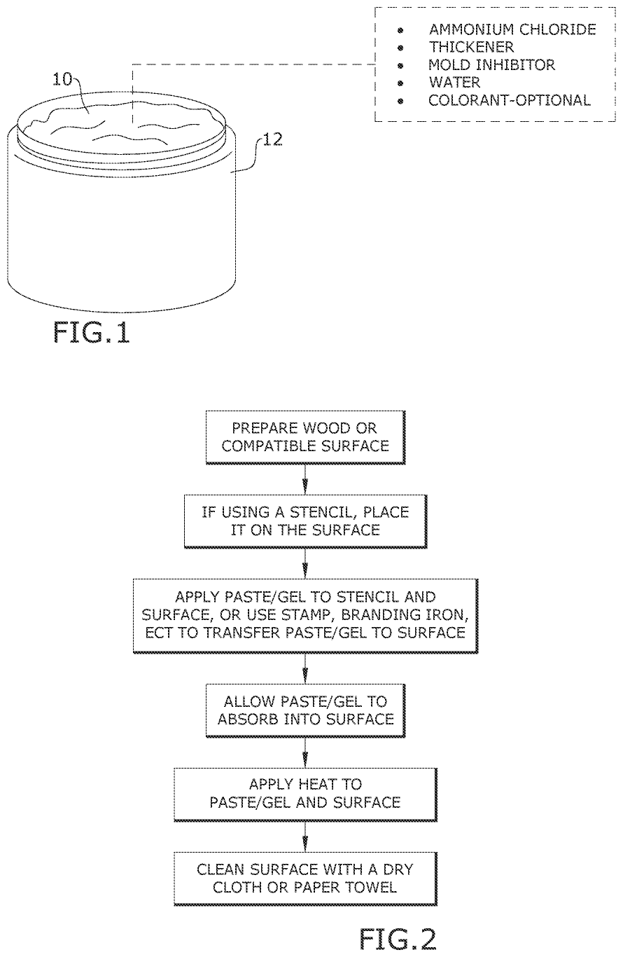

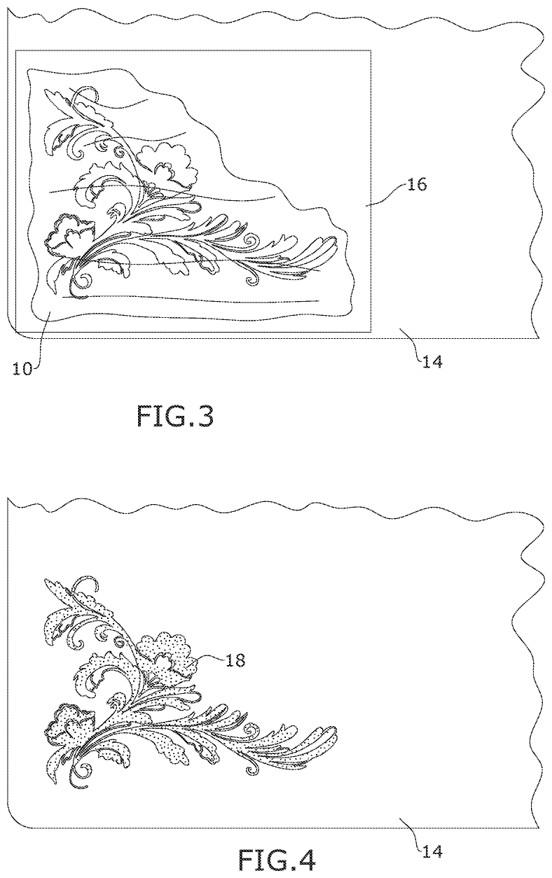

Referring to FIGS. 1 through 4, paste/gel 10, jar 12, surface 14, stencil 16, burned design 18.

It should be understood, of course, that the foregoing relates to exemplary embodiments of the invention and that modifications may be made without departing from the spirit and scope of the invention as set forth in the following claims.

What is claimed is:

1. A pyrography composition comprising:
ammonium chloride in an amount of about 2% to about 15% by weight of a total composition;
a thickener in an amount of about 10% to about 40% by weight of the total composition; and
water in an amount of about 50% to about 75% by weight of the total composition.

2. The pyrography composition of claim 1, further comprising a colorant in an amount of about 0.5% to about 10% by weight of the total composition.

3. The pyrography composition of claim 1, further comprising a preservative in an amount of about 0.5% to about 10% by weight of the total composition.

4. The pyrography composition of claim 1, wherein a weight ratio of the thickener to the ammonium chloride is about 1:1 to about 5:1.

5. The pyrography composition of claim 1, wherein the pyrography composition is a gel or a paste.

6. The pyrography composition of claim 1, wherein the ammonium chloride is present in an amount of about 8% to about 12% by weight, the thickener is present in an amount of about 13% to about 38% by weight, the water is present in an amount of about 54% to about 75% by weight, a colorant is present in an amount of about 0.5% to 10% by weight, and a preservative is present in an amount of about 0.5% to about 5% by weight, such that the ammonium chloride, the thickener, the water, the colorant, and the preservative total 100% and the pyrography composition is a non-Newtonian fluid.

7. A method of manufacturing a pyrography composition, comprising:
providing ammonium chloride in an amount of about 2% to about 15% by weight of a total composition; a thickener in an amount of about 10% to about 40% by weight of the total composition; and water in an amount of about 50% to about 75% by weight of the total composition; and
mixing the ammonium chloride, the thickener, and the water to form a non-Newtonian fluid.

8. The method of claim 7, further comprising providing a colorant in an amount of about 0.5% to about 10% by weight prior to mixing.

9. The method of claim 7, further comprising providing a preservative in an amount of about 0.5% to about 10% by weight prior to mixing.

10. The method of claim 7, wherein the ammonium chloride is provided in an amount of about 8% to about 12% by weight, the thickener is provided in an amount of about 13% to about 38% by weight, the water is provided in an amount of about 54% to about 75% by weight, and the method further comprises providing a colorant in an amount of about 0.5% to 10% by weight, and a preservative in an amount of about 0.5% to about 5% by weight prior to mixing, such that the ammonium chloride, the thickener, the water, the colorant, and the preservative total 100%.
